(19) United States
(12) Patent Application Publication
(10) Pub. No.: US 2004/0263662 A1
(43) Pub. Date: Dec. 30, 2004

(54) Image-processing apparatus, image-taking apparatus, and image-processing program

(75) Inventors: Noriyuki Okisu, Osakasayama-Shi (JP); Rieko Izume, Sakai-Shi (JP); Motohiro Nakanishi, Kobe-Shi (JP); Takehisa Yamaguchi, Ikom-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD

(21) Appl. No.: 10/674,260

(22) Filed: Sep. 29, 2003

(30) Foreign Application Priority Data
Jun. 30, 2003 (JP) 2003-188030

(51) Int. Cl. H04N 5/222

(52) U.S. Cl. 348/333.02

(57) ABSTRACT

An apparatus that permits annotation information to be added to a region within an image permits easy specification of a region and permits even omission of specification of a region. When an image to which to add annotation information is specified, a region at the center of the image is set and displayed as a region to which to add the annotation information. If this region does not agree with the region to which the user wants to add the annotation information, the user, by moving, enlarging, or reducing the displayed region frame, specifies the desired region; otherwise, specification of a region can be omitted. The region that was used to adjust the focus of a taking lens when the image was captured may be set as a region to which to add the annotation information.

This application is based on Japanese Patent Application No. 2003-188030 filed on Jun. 30, 2003, the contents of which are hereby incorporated by reference.

### BACKGROUND OF THE INVENTION

1. Field of the Invention

The present invention relates to an image-processing apparatus and a program that permit annotation information to be added to a region within an image.

2. Description of the Prior Art

It has been proposed to add annotation information to the whole of, or a region within, an image captured with a digital camera. This helps to enhance images' capability of conveying information and to facilitate management of images. An association between a given piece of annotation information and a given image, or a region within it, is created manually by the user. Typically, the user first selects and displays an image to which the user wants to add annotation information, and then set a region on the image.

Japanese Patent Application Laid-Open No. 2002-55748 proposes a method for efficiently adding annotation information to a large number of images stored in an image database. According to this method, a plurality of icons associated with individual pieces of annotation information are displayed along with images, and the user is invited to drag and drop the icon associated with particular annotation information that the user wants to add onto the region on an image to which the user wants to add the particular annotation information. This permits an association to be created between a given image, or a region within it, and a given piece of annotation information.

Conventional methods, including the one proposed in the patent publication mentioned above, require the user to perform some operation to specify a region (at least its position) to which to add annotation information. That is, unless the user specifies a region, the user cannot add any annotation information. Specifying a region is very useful in creating a strict association between annotation information and a region within an image. However, to make clear the part of an image to which the user wants to add annotation information, it often suffices to establish an association between only a portion of the part of the image to which to add annotation information and a region, or conversely between the part of the image to which to add annotation information and only a portion of a region. Thus, it is not always necessary to specify a region. Moreover, selecting from among a large number of images one to which to add annotation information and then specifying a region on that image involves too many steps of operation. This complicates the operation that needs to be performed to add annotation information to an image.

### SUMMARY OF THE INVENTION

An object of the present invention is to provide an apparatus and a program that permit easy specification of a region to which to add relevant information such as annotation information and that permit even omission of specification of a region.

To achieve the above object, according to one aspect of the present invention, an image-processing apparatus is provided with: a display that displays an image; a selector that selects an image displayed on the display; a recorder that adds relevant information to a region within an image selected by the selector and that then records the relevant information on a recording medium; a setter that, when an image to which to add relevant information is selected by the selector, initially sets a predetermined region within the image as a region to which to add the relevant information; and a changer that changes the region to which to add the relevant information from the predetermined region initially set by the setter to a region specified by a user.

In this image-processing apparatus, when an image is selected, a default region to which to add relevant information such as annotation information is set, and, unless a region is expressly specified thereafter, the relevant information is added to the default region. If the part of the image to which the user wants to add the relevant information largely agrees with the default region, the user can omit specification of a region. If the user expressly specifies a region, the region to which to add the relevant information is changed to the specified region. This permits the user to choose to establish a strict association between relevant information and a particular part of the image.

Advisably, the display displays the predetermined region initially set by the setter and, when the changer changes the region to which to add the relevant information to the region specified by the user, changes the displayed region to the region specified by the user. This makes it easy for the user to grasp with what part of the image the annotation information is associated. Moreover, it is also possible to specify a region by modifying the default region displayed. This makes easy the operation required to specify a region.

Advisably, if relevant information has already been added to the image selected by the selector, the display displays a region to which the already added relevant information is added and the predetermined region initially set by the setter. This permits the user to know that annotation information has already been added and to what region it is added. On the basis of this knowledge, the user can decide whether to add new annotation information or not and where to add it.

In that case, advisably, the display displays in different manners the region to which the already added relevant information is added and the predetermined region initially set by the setter.

The predetermined region initially set by the setter may be a region at the center of the image. When an image is captured, the point of interest within the capturing subject is typically caught at the center of the image. Accordingly, by using a central region as the default region, specification of a region can more likely be omitted.

The predetermined region initially set by the setter may be a region used for focus adjustment when the image selected by the selector was captured. When an image is captured, the point of interest within the capturing subject is typically brought into focus. Accordingly, by using the region used for focus adjustment as the default region, specification of a region can very likely be omitted.

According to another aspect of the present invention, an image-taking apparatus is provided with: an image sensor that captures an image; a display that displays the image captured by the image sensor; a selector that selects an image displayed on the display; a recorder that adds relevant information to a region within an image selected by the selector and that then records the relevant information on a recording medium; a setter that, when an image to which to add relevant information is selected by the selector, initially sets a predetermined region within the image as a region to which to add the relevant information; and a changer that changes the region to which to add the relevant information from the predetermined region initially set by the setter to a region specified by a user.

According to still another aspect of the present invention, in a program product is stored a program that makes a computer perform the steps of: displaying an image on a display and selecting the image to which to add relevant information; initially setting a predetermined region within the selected image as a region to which to add the relevant information; changing the region to which to add the relevant information from the initially set predetermined region to a region specified by a user; and adding the relevant information to the changed region and recording the relevant information.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a perspective view of the digital camera of a first embodiment of the invention;

FIG. 2 is a rear view of the digital camera;

FIG. 3A is a diagram showing an example of a parent image to which annotations have been added by the digital camera;

FIG. 3B is a diagram showing an example of an annotation image added to the parent image shown in FIG. 3A by the digital camera;

FIG. 4 is a diagram showing the structure of file folders in the digital camera;

FIG. 5 is a diagram schematically showing the circuit configuration of the digital camera;

FIG. 6 is a flow chart showing the flow of operations performed to set the photographing mode when electric power starts to be supplied to the digital camera;

FIG. 7 is a diagram showing the main menu displayed by the digital camera to permit selection of the photographing mode;

FIG. 8 is a flow chart showing the flow of operations performed to change the photographing mode in the digital camera;

FIG. 9 is a flow chart showing the flow of operations performed in the image annotation photographing mode in the digital camera;

FIG. 10 is a diagram showing an example of the screen displayed by the digital camera to permit selection of a parent image to which to add an annotation;

FIG. 11 is a flow chart showing the flow of operations performed to select a parent image in the digital camera;

FIG. 12 is a diagram showing an example of the warning displayed by the digital camera when an image unsuitable as a parent image is selected;

FIG. 13 is a diagram showing an example of the initial screen displayed by the digital camera to permit setting of a region within a parent image;

FIG. 14 is a diagram showing an example of a screen including a region having its position changed in the digital camera;

FIG. 15 is a diagram showing an example of a screen including a region having its position and size changed in the digital camera;

FIG. 16 is a diagram showing an example of the screen displayed by the digital camera to permit setting of a region within an image to which an annotation has already been added;

FIG. 17 is a flow chart showing the flow of operations performed to set a region within a parent image in the digital camera;

FIG. 18 is a flow chart showing the flow of operations performed in the sound annotation recording mode in the digital camera;

FIG. 19 is a flow chart showing the flow of operations performed to end the capturing of an annotation image and the recording of an annotation sound in the digital camera;

FIG. 20 is a flow chart showing the flow of operations performed when the image annotation photographing mode or the sound annotation recording mode is started for the first time after electric power starts to be supplied in the digital camera;

FIG. 21 is a flow chart showing the flow of operations performed when a recording medium is mounted while electric power is being supplied in the digital camera;

FIG. 22 is a flow chart showing the flow of operations performed when an external device is disconnected while electric power is being supplied in the digital camera;

FIG. 23 is a flow chart showing the flow of operations performed to present a quick view in the digital camera;

FIG. 24 is a flow chart showing the flow of operations performed to delete a file during a quick view in the digital camera;

FIG. 25 is a flow chart showing another flow of operations performed to start a quick view when the region setting screen is being displayed in the digital camera;

FIG. 26 is a diagram showing another main menu displayed by the digital camera to permit selection of the photographing mode;

FIG. 27 is a flow chart showing the flow of operations performed in the annotation photographing mode in the digital camera;

FIG. 28 is a diagram showing the screen displayed by the digital camera to permit choice of whether to use as a parent image an image that is going to be captured or an image that has already been recorded;

FIG. 29 is a diagram showing the screen displayed by the digital camera to permit choice of whether to use an image or sound as an annotation to be added to the parent image;

FIG. 30 is a flow chart showing the flow of operations performed to set the photographing mode when electric power starts to be supplied to the digital camera;

FIG. 31 is a flow chart showing the flow of operations performed to change the photographing mode in the digital camera;

FIG. 32 is a diagram showing an example of the screen displayed by the digital camera to permit choice of whether to use as a parent image an image that is going to be captured or an image that has already been recorded and which of the already recorded images to use as a parent image;

FIG. 33 is a front view of the personal computer of a second embodiment of the invention;

FIG. 34 is a diagram showing an example of the screen displayed by the personal computer to permit selection of a parent image to which to add an annotation; and

FIG. 35 is a diagram showing an example of the screen displayed by the personal computer to permit setting of a region within a parent image.

### DESCRIPTION OF THE PREFERRED EMBODIMENTS

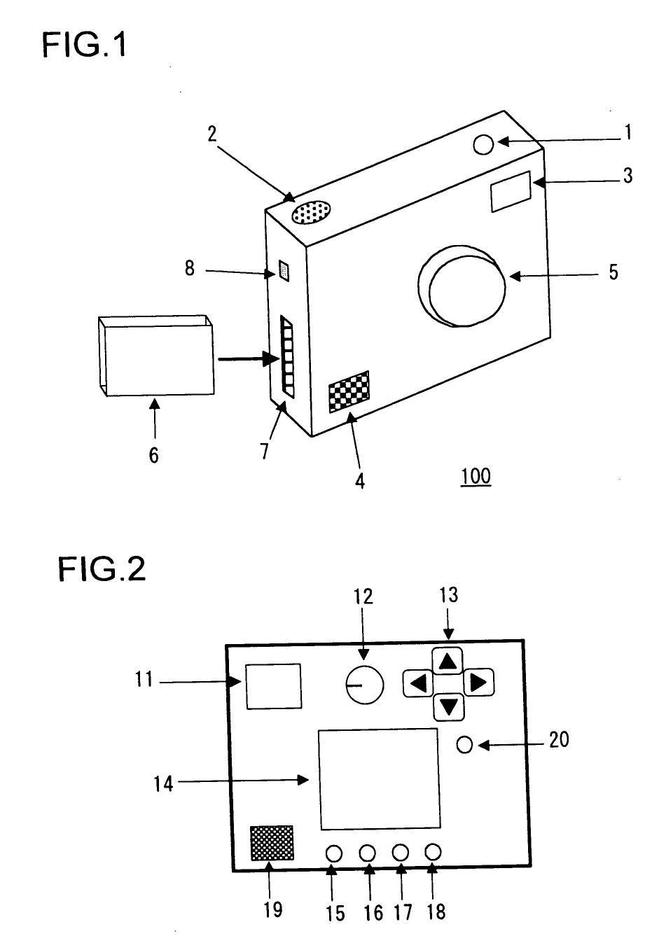

Hereinafter, embodiments of the present invention will be described with reference to the drawings. The outward appearance of the digital camera 100 of a first embodiment of the invention is shown in a perspective view in FIG. 1 and in a rear view in FIG. 2. The digital camera 100 has, on the top face thereof, a power button 1 and a shutter button 2, has, on the front face, a viewfinder front window 3, a microphone 4, and a taking lens 5, has, on a side face, a slot 7 for mounting a recording medium 6 and an external device connection terminal 8, and has, on the rear face, a viewfinder rear window 11, a mode selection dial 12, four direction keys 13, a liquid crystal display 14, five operation buttons 15, 16, 17, 18, and 20, and a loudspeaker 19.

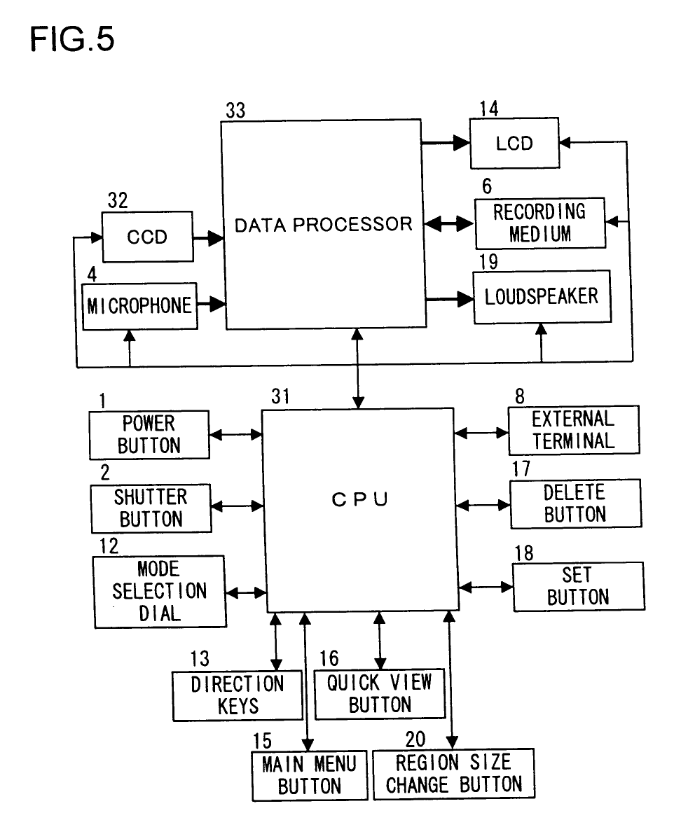

The digital camera 100 incorporates a CCD area sensor 32 (see FIG. 5), and captures an image by imaging the light from a capturing object through the taking lens 5 onto the sensor 32. The captured image is recorded on the recording medium 6, and is displayed on the display 14. An image already recorded on the recording medium 6 can also be reproduced and displayed on the display 14.

The digital camera 100 has a capability of adding annotation information (an annotation) to a region within an image. Hereinafter, this capability will be referred to as the annotating capability, and the mode in which the digital camera 100 executes the annotating capability will be referred to as the annotation mode. Here, two types of annotation are handled, namely images and sounds. An annotation in the form of an image will be referred to as an annotation image, and an annotation in the form of a sound will be referred to as an annotation sound. An image to which an annotation is going to be added or has already been added will be also referred to as a parent image.

The microphone 4 is used to record an annotation sound, and the loudspeaker 19 is used to reproduce an annotation sound. In the annotation mode, the operation buttons 15 to 18 and 20 are operated to select an image, to set a region within the image, and for other purposes. The operation buttons 15, 16, 17, 18, and 20 are referred to as the main menu button, quick view button, delete button, set button, and region size change button, respectively.

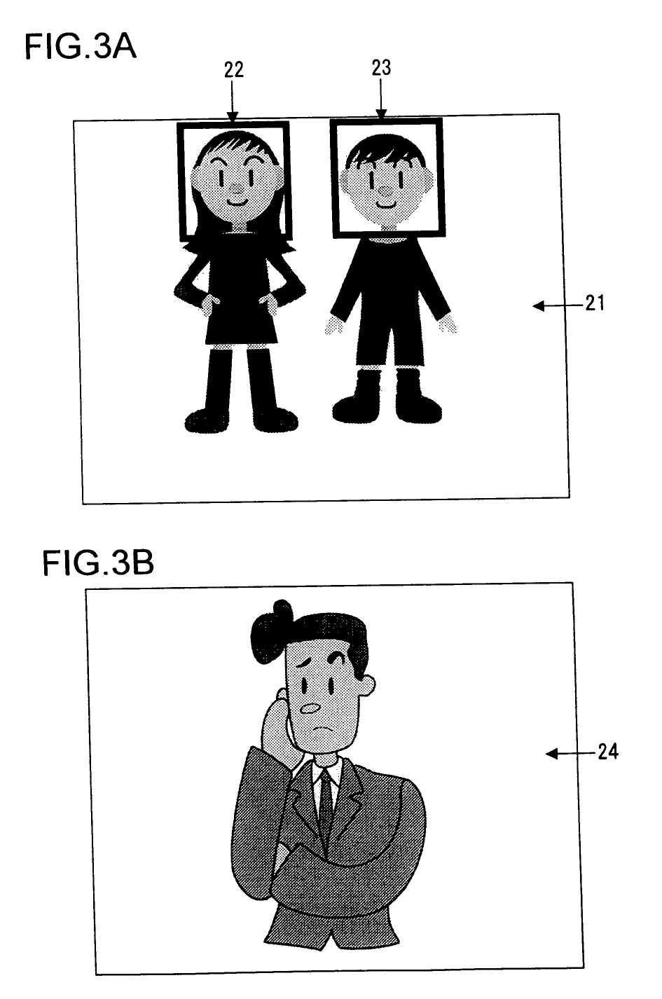

Now, the annotation capability of the digital camera 100 will be described with reference to FIGS. 3A and 3B. FIG. 3A shows an example of a parent image having annotations added thereto. Annotations are added to regions (of which there may be one or more) within the parent image 21. Within the image 21, two regions are set, and the corresponding region frames 22 and 23 are displayed. These regions each have an annotation added thereto. It should be noted that the region frames 22 and 23 are displayed merely for display on the liquid crystal display 14, and are not included in the image 21 itself.

FIG. 3B is an example of an annotation image added to the parent image 21. This image 24 is a photograph of the father of the girl that appears in the region frame 22. On the other hand, to the region frame 23 is added, for example, an annotation sound that speaks “this boy is John.”

The file of the annotation image 24 and the file of the annotation sound are associated with the file of the image 21, and the association among these files is recorded in a predetermined file called an association file. When all these files are transferred to a personal computer, they can be viewed on the personal computer. This permits better understanding of the parent image 21 and better interpersonal communication.

Table 1 shows the contents of an association file.

TABLE 1
Contents of an Association File

| Item | Content |
|---|---|
| 1 | Parent image file name |
| 2 | Parent image file creation date and time |
| 3 | Annotation region position (coordinates of the upper left corner) |
| 4 | Annotation region size (vertical and horizontal dimensions) |
| 5 | Annotation file name |
| 6 | Annotation file creation date and time |

There are as many sets of items 3 to 6 as there are annotations added to the parent image. The association file is updated whenever the association information needs to be changed, for example when a new annotation is added, when a file is deleted, or in other cases.

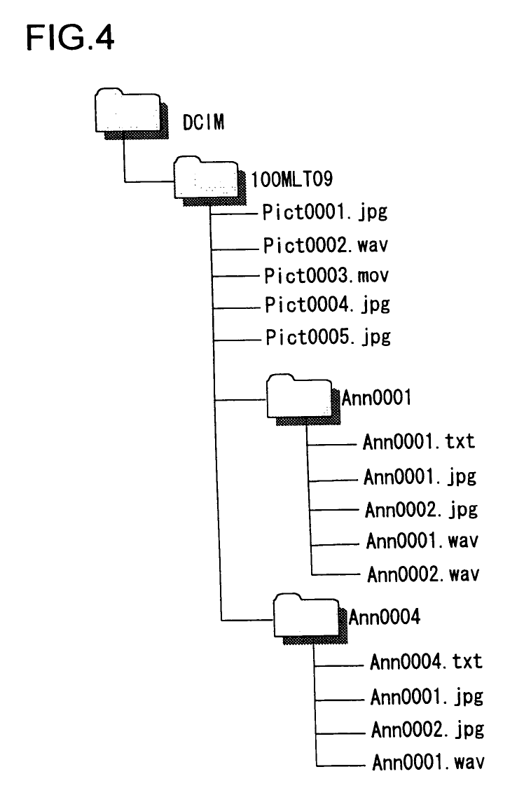

FIG. 4 shows the structure of file folders in the digital camera 100. In this example, the files “Pict001.jpg” and “Pict0004.jpg” are parent image files. These files are placed in a DCF (digital camera format) folder named “100MLT09,” in which there are annotation folders “Ann001” and “Ann0004.” The numbers “0001” and “0004” appended to the annotation folders are the same as those appended to the respective parent files Pict0001.jpg” and “Pict0004.jpg,” and this permits association between parent images and annotation folders.

In each annotation folder, there are stored an association file, annotation image files, and annotation sound files. For example, in the folder “Ann0001,” the file “Ann0001.txt” is the association file, the files “Ann0001.jpg” and “Ann0002.jpg” are annotation image files, and the files “Ann0001.wav” and “Ann0002.wav” are annotation sound files.

The digital camera 100 has, with respect to capturing of still images, four modes, namely a normal photographing mode, a document photographing mode, an image annotation photographing mode, and a sound annotation recording mode. The normal photographing mode is for ordinary capturing, with the digital camera 100 functioning as a common digital camera. The document photographing mode is for capturing a character-based subject such as a document or a manuscript on a whiteboard. The image annotation photographing mode is for adding an annotation image to a parent image. The sound annotation recording mode is for adding an annotation sound to a parent image. The annotation mode mentioned earlier thus includes the image annotation photographing mode and the sound annotation recording mode.

Information relating to in which photographing mode an image or sound was captured or recorded is recorded in the tag (header) of the respective file. This photographing mode information is referred to in order to indicate, when an image or sound is reproduced and displayed or played back, in which photographing mode the image or sound was captured or recorded. The photographing mode information is recorded in a one-byte region in the tag. Table 2 shows the individual bits of that region and what a “1” in each of them stands for.

TABLE 2
Photographing Mode Information

| Bit | Meaning |
|---|---|
| 0 | An image captured in the normal photographing mode |
| 1 | An image captured in the document photographing mode |
| 2 | A parent image in the image annotation photographing mode |
| 3 | An annotation image captured in the image annotation photographing |
| | mode |
| 4 | A parent image in the sound annotation recording mode |
| 5 | An annotation sound recorded in the sound annotation |
| | recording mode |
| 6 | A movie |
| 7 | A sound other than an annotation sound |

These bits are updated whenever they need to be changed, for example when an image is captured, when an annotation is added, and in other cases. Two or more of the bits may be “1” simultaneously. For example, when an image captured in the normal photographing mode is used as a parent image in the sound annotation recording mode, the bits 0 and 4 are “1” simultaneously.

FIG. 5 schematically shows the circuit configuration of the digital camera 100. The output signal of the CCD sensor 32 is converted by a data processor 33 into digital image data that represents an image. This image data is displayed on the liquid crystal display 14, and is recorded on the recording medium 6 in response to a command to that effect. The output signal of the microphone 4 is converted by the data processor 33 into digital sound data. This sound data is recorded on the recording medium 6. An image recorded on the recording medium 6 can be displayed on the liquid crystal display 14 through the data processor 33, and a sound recorded on the recording medium 6 can be output from the loudspeaker 19 through the data processor 33. All such operations are controlled by a CPU 31.

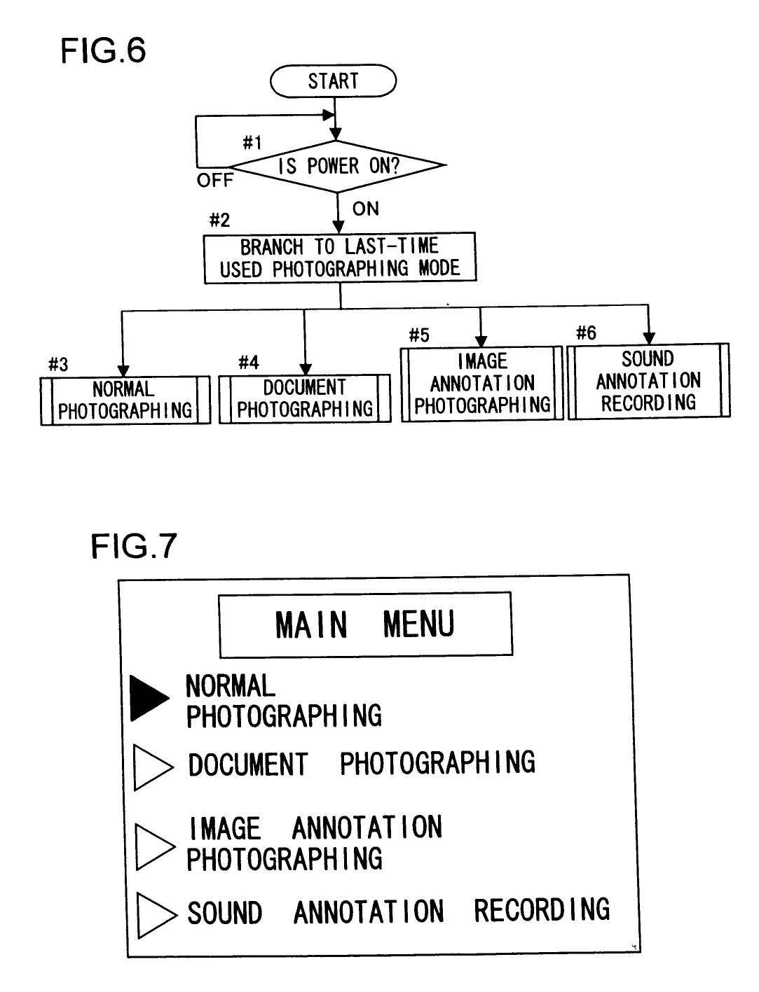

FIG. 6 shows the flow of operations performed to set the photographing mode when electric power starts to be supplied. The digital camera 100, when the supply of electric power thereto is stopped, stores the photographing mode at that moment, and, when the supply of electric power thereto is started (step #1), restores the stored photographing mode (steps #2 to #6).

On the liquid crystal display 14 are displayed, apart from images, various menu screens that guide the user through various operations such as switching among the different photographing modes. FIG. 7 shows the main menu displayed on the liquid crystal display 14. The main menu permits selection of one from among the four photographing modes mentioned earlier. In the example shown in FIG. 7, the normal photographing mode is selected. One of the modes is selected by operation of the four direction keys 13, and is established by operation of the set button 18. This main menu can be reached from anywhere by operation of the main menu button 15.

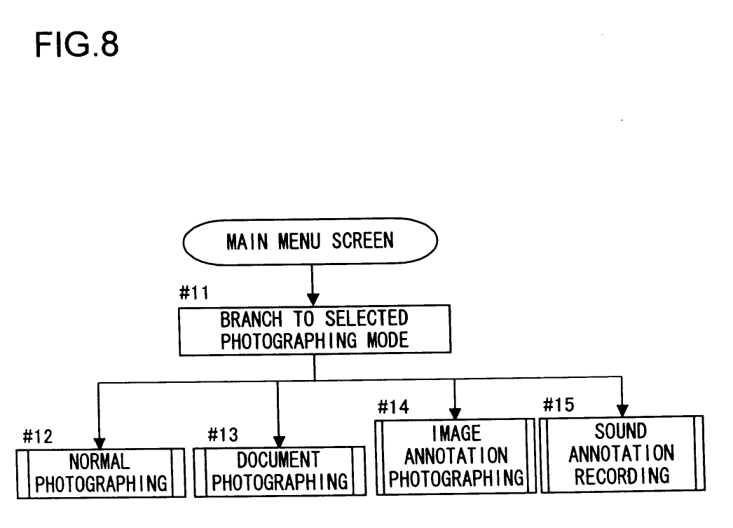

FIG. 8 shows the flow of operations performed to change the photographing mode in the main menu. The photographing mode is set to the mode that is being selected at the moment that the set button 18 is operated (#11 to #15).

If, in step #3 shown in FIG. 6 or in step #12 shown in FIG. 8, the normal photographing mode has been established, the digital camera 100 executes ordinary capturing operations as does a common digital camera. On completion of capturing, the digital camera 100 creates an image file, and registers photographing mode information in its tag.

If, in step #4 shown in FIG. 6 or in step #13 shown in FIG. 8, the document photographing mode has been established, the digital camera 100 executes ordinary capturing operations as does a common digital camera, but does not shoot a flash by default irrespective of whether the environment is bright or dim. On completion of capturing, the digital camera 100 creates an image file, and registers photographing mode information in its tag.

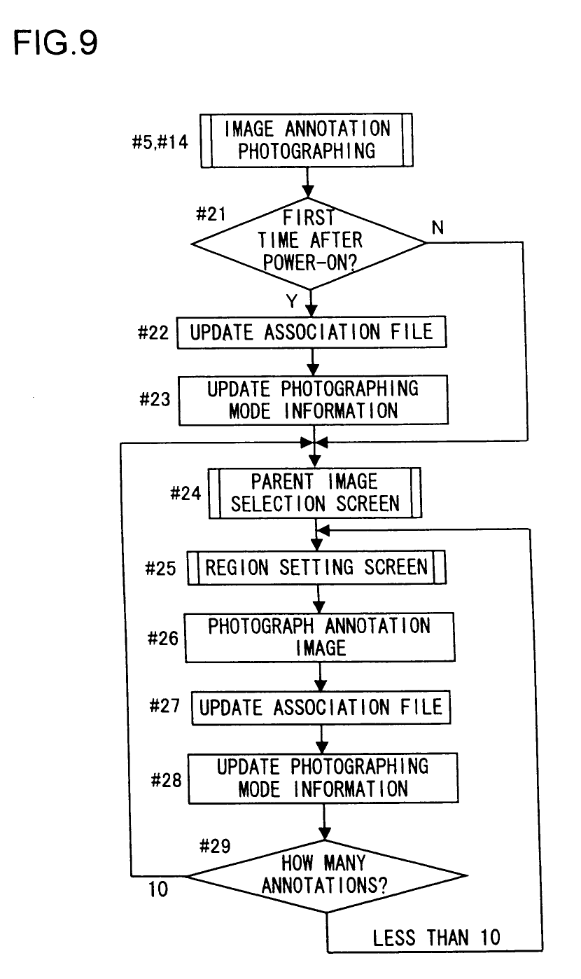

FIG. 9 shows the flow of operations performed when, in step #5 shown in FIG. 6 or in step #14 shown in FIG. 8, the image annotation photographing mode has been established. If this is the first time that this mode is established after the start of the supply of electric power (step #21), the association file is updated (#22), and the photographing mode information is updated (#23). This is to cope with any updating of the files on the recording medium 6 by an external device. On completion of this updating, the digital camera 100 displays a parent image selection screen (#24).

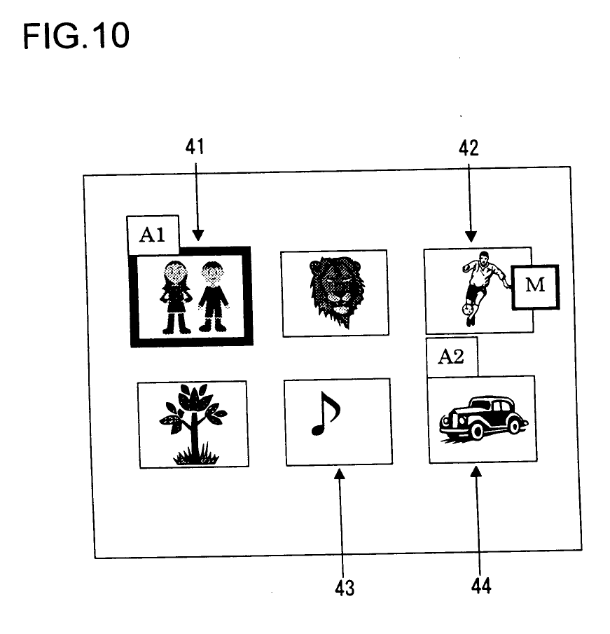

FIG. 10 shows an example of the parent image selection screen. In the parent image selection screen, the images and sounds stored in the files recorded on the recording medium 6 are displayed as thumbnail images. Here, since sounds themselves cannot be displayed, for a sound file, a thumbnail image 43 of a musical note is displayed. The user selects a parent image from among the images displayed. In the example shown in FIG. 10, the image 41 of which the frame is indicated with a thick line is being selected. One of the images is selected by operation of the four direction keys 13, and is established by operation of the set button 18.

The symbol “A1” displayed contiguous with the thumbnail image 41 indicates that the image of the corresponding file has already been used as a parent image in the image annotation photographing mode. On the other hand, the symbol “A2” displayed contiguous with the thumbnail image 44 indicates that the image of the corresponding file has already been used as a parent image in the sound annotation recording mode. In this way, the properties of images are displayed on the basis of their photographing mode information to facilitate selection of a parent image. Incidentally, the symbol “M” displayed overlapping the thumbnail image 42 indicates that the image of the corresponding file is a movie.

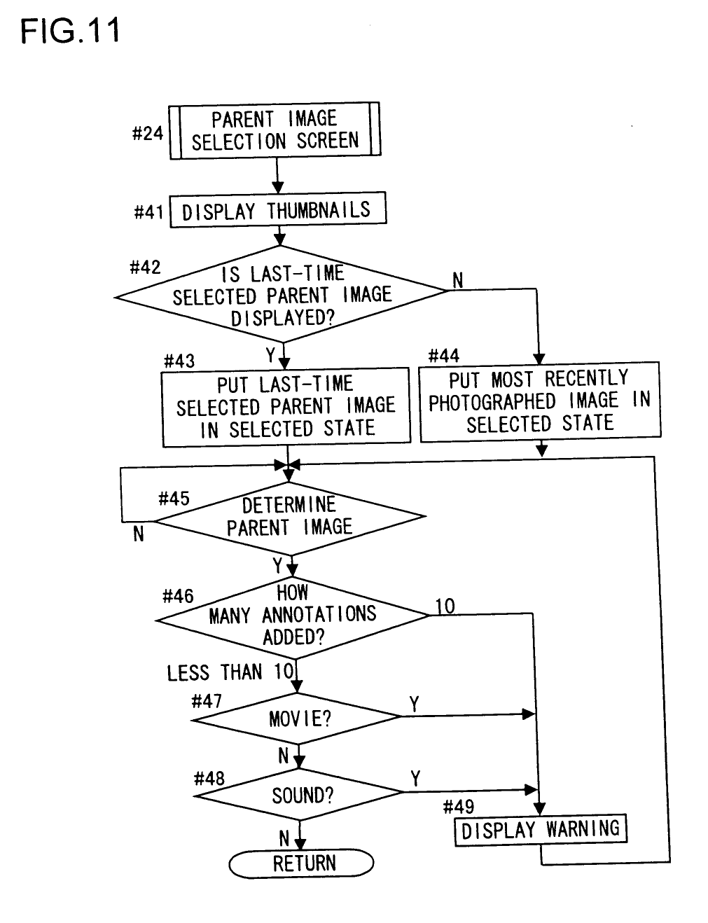

FIG. 11 shows the flow of operations performed to select a parent image. First, thumbnail images are displayed (step #41). If these images include the one that was selected as a parent image last time, that image is displayed in a selected state; if not, the image that was captured most recently is displayed in a selected state (#42 to #44). The user is likely to select as a parent image the one that the user selected as a parent image last time. Accordingly, by displaying in a selected state the image that was selected as a parent image last time, it is possible to alleviate the operation for selection of a parent image.

To minimize unnecessary power consumption, the digital camera 100 has an automatic power-off capability, whereby the supply of electric power is automatically stopped when the user makes no operation for a predetermined period of time. Thus, the automatic power-off capability may work while the user is suspending operation after selecting a parent image. Even in that case, the user can continue with operation without newly selecting a parent image. Here, the image that was captured most recently may be displayed in a selected state regardless of whether or not there is any image that was selected as a parent image last time.

Alternatively, instead of the image that was selected as a parent image last time, an image to which an annotation has already been added may be displayed in a selected state. The user is likely to add a new annotation to an image to which an annotation has already been added. Accordingly, by displaying such an image in a selected state, it is possible to alleviate the operation for selection of a parent image. In that case, among images to which annotations have already been added, the one that was captured most recently may be displayed in a selected state, or the one to which the newest annotation has been added may be displayed in a selected state.

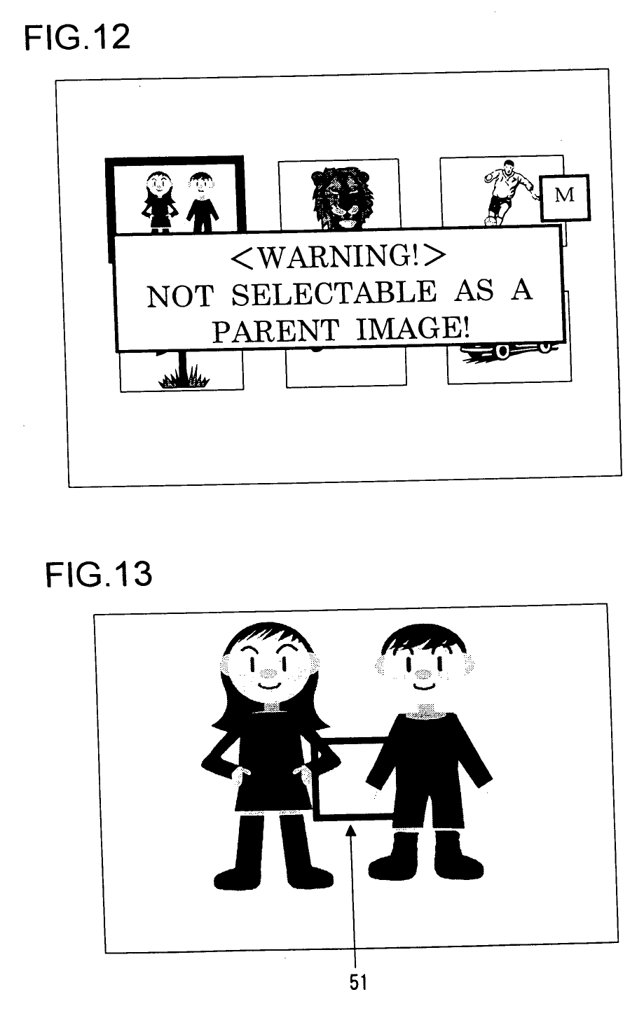

Next, one of the images displayed is selected by operation of the direction keys 13, and the one that is being selected at the moment that the set button 18 is operated is determined as a parent image (#45). Then, whether the determined image is usable as a parent image or not is checked (#46 to #48). Specifically, it is checked whether or not the maximum number of annotations that can be added to a parent image will be exceeded by adding a new annotation (in the example being discussed, the maximum number is ten), and whether or not the selected file is that of a movie or sound. If one of these applies, a warning as shown in FIG. 12 is displayed (#49), and the flow then returns to step #45.

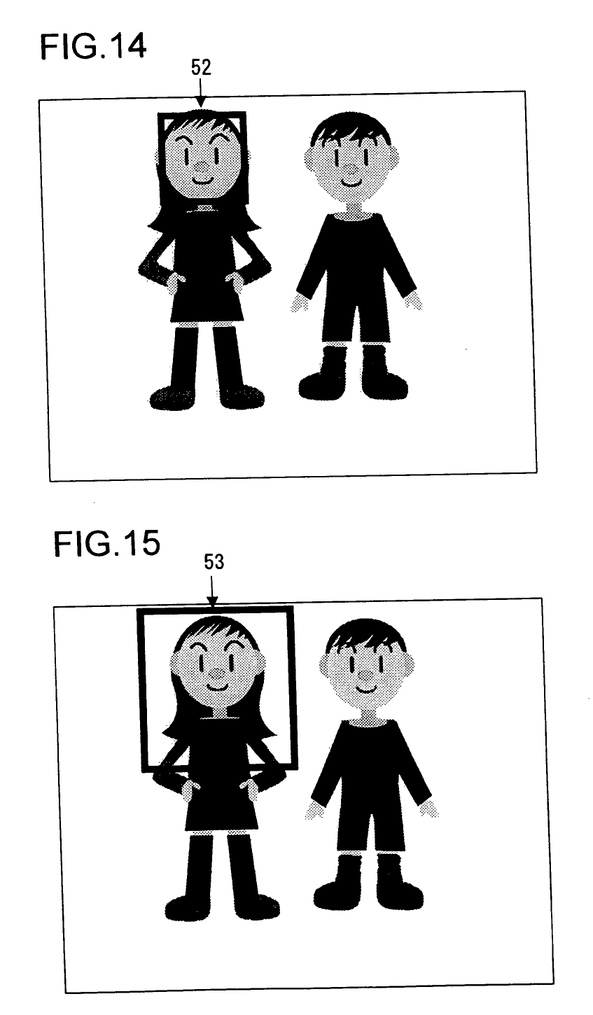

On completion of selection of a parent image, a region setting screen is displayed that permits setting of the position and size of a region within the parent image to which to add an annotation image (FIG. 9, step #25). FIG. 13 shows an example of the initial state of this region setting screen. In the region setting screen, along with the selected parent image is displayed a default region frame 51 located at the center of the image. The user moves this region frame 51 to a position where the user wants to add an annotation. The region frame 51 is moved by operation of the four direction keys 13. When the user wants to change the size of the region to which to add an annotation, the user enlarges or reduces the region frame 51. The region frame 51 is enlarged or reduced by operation of the region size change button 20. FIG. 14 shows an example of the region setting screen including a region frame 51 having its position changed, and FIG. 15 shows an example of the region setting screen including a region frame 53 having both its position and size changed.

The region that is displayed in the region setting screen by default may be the region that was used for focus adjustment when the parent image was captured. The digital camera 100 adopts servo-type automatic focus adjustment whereby the focus of the taking lens 5 is varied in the direction in which increasingly high contrast is obtained until the focus is located at where the maximum contrast is obtained. As a region in which to detect contrast, either a whole image or part thereof can be selected, and, as part of an image, one of a plurality of different regions within the image, including one located at the center thereof, can be selected. By using as a default region the one among those regions which was actually used to adjust focus when the parent image was captured, it is possible to easily add an annotation to the part of an image which was of particular interest to the user when the user captured it. The region that was used for focus adjustment is registered in the tag of the image file.

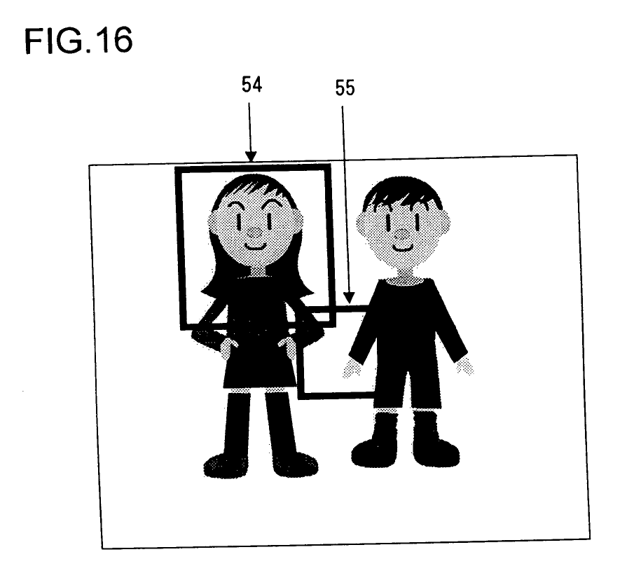

FIG. 16 shows the region setting screen displayed in a case where an annotation has already been added to the selected parent image. The region frame 54 corresponds to the annotation that has already been added, and the region frame 55 is the one displayed by default to permit a new annotation to be added. The region frames 54 and 55 are displayed in different manners, such as in different colors, different line types, or different line thicknesses. When two or more annotations have already been added, the region frames corresponding to the individual annotations are all displayed in different manners.

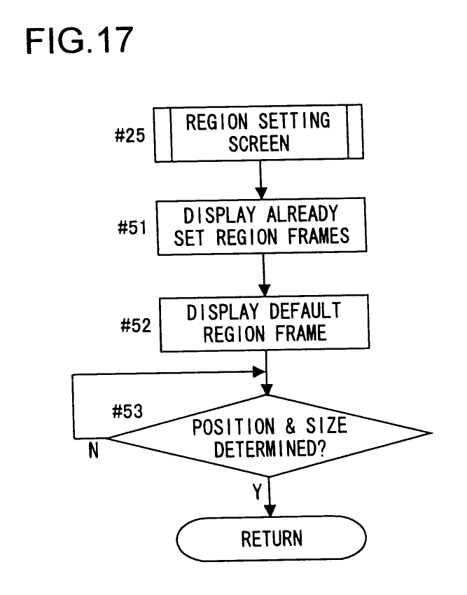

FIG. 17 shows the flow of operations performed to set a region. First, if there is any already added annotation, its region frame is displayed (step #51), and then a default region frame for an annotation to be newly added is displayed (#52). Then, in response to the user's operation, the desired position and size of the region are determined.

Now, back in FIG. 9, the flow of operations in the image annotation photographing mode continues as follows. After the region setting screen is displayed and a region to which to add an annotation is set therein, an annotation image is captured (step #26), then the association file is updated (#27), and then the photographing mode information is updated (#28). Then, whether or not the total number of annotations added to the parent image has reached the maximum number (here, as described earlier, ten) is checked (#29). If the total number has reached the maximum number, the flow returns to step #24 to permit selection of a new parent image; if not, the flow returns to step #25 to permit setting of a region within the same parent image to which to add a new annotation.

When the user wants to select a new parent image before the total number of annotations reaches ten, the user can operate the main menu button 15 to return from step #25 to step #24. When the main menu button 15 is operated in step #24, the main menu described earlier, i.e., the menu that permits selection of the photographing mode, is displayed.

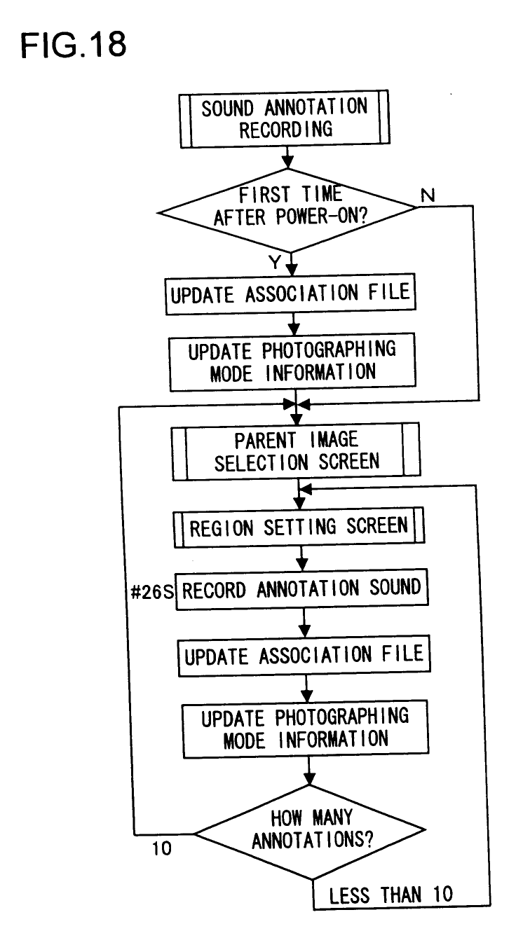

FIG. 18 shows the flow of operations performed when, in step #5 shown in FIG. 6 or in step #14 shown in FIG. 8, the sound annotation recording mode has been established. Here, in place of the step of capturing an annotation image (step #26), there is inserted a step of recording an annotation sound (step #26S).

The updating of the association file and of the photographing mode information is executed at the time points (1) to (4) described below according to the rules described below.

(1) On completion of capturing of an annotation image or recording of an annotation sound.

a) If no annotation has already been added to the parent image, a new annotation folder and a new association file are created, and annotation information is registered in the association file. Moreover, the photographing mode information of the parent image file is updated, and photographing mode information is registered in the created annotation image or sound file.

b) If any annotation has already been added to the parent image, new annotation information is additionally registered in the association file. Moreover, the photographing mode information of the parent image file is updated, and photographing mode information is registered in the created annotation image or sound file.

(2) When the image annotation photographing mode or sound annotation recording mode is established for the first time after the start of the supply of electric power.

a) For a given annotation folder, whether the parent image file, annotation image files, and annotation sound files registered in the association file stored therein exist in that annotation folder or not is checked. Then, portions of the association file which relate to any nonexistent file are deleted.

b) For a given annotation folder, if none of the annotation image files and annotation sound files registered in the association file stored therein exists, that association file and the annotation folder are deleted.

c) For a given annotation folder, if the parent image file registered in the association file stored therein does not exist, that association file and the annotation folder (along with the annotation image files and annotation sound files stored therein) are deleted.

d) For a given annotation folder, if no association file exists therein, the annotation folder (along with the annotation image files and annotation sound files stored therein) is deleted.

e) The photographing mode information of the parent file, annotation image files, and annotation sound files is updated so as to be consistent with the operations a) to d) above.

f) The operations a) to e) above are executed for all annotation folders.

(3) When the recording medium is mounted while electric power is being supplied. The same operations as described under (2) above are executed.

(4) When an external device is disconnected while electric power is being supplied.

The same operations as described under (2) above are executed.

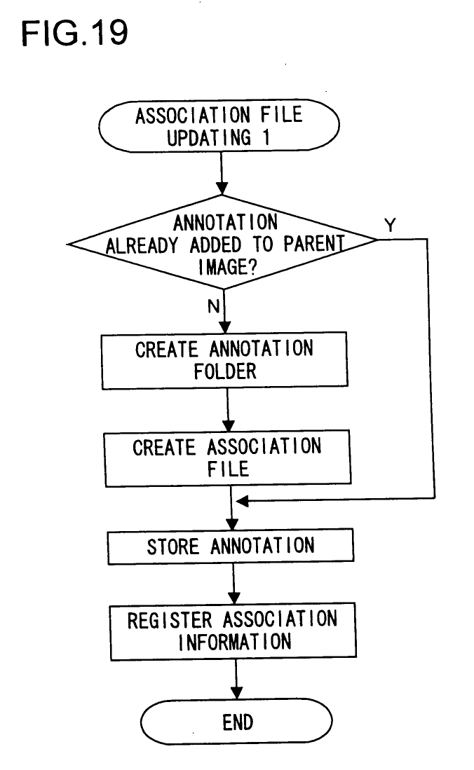

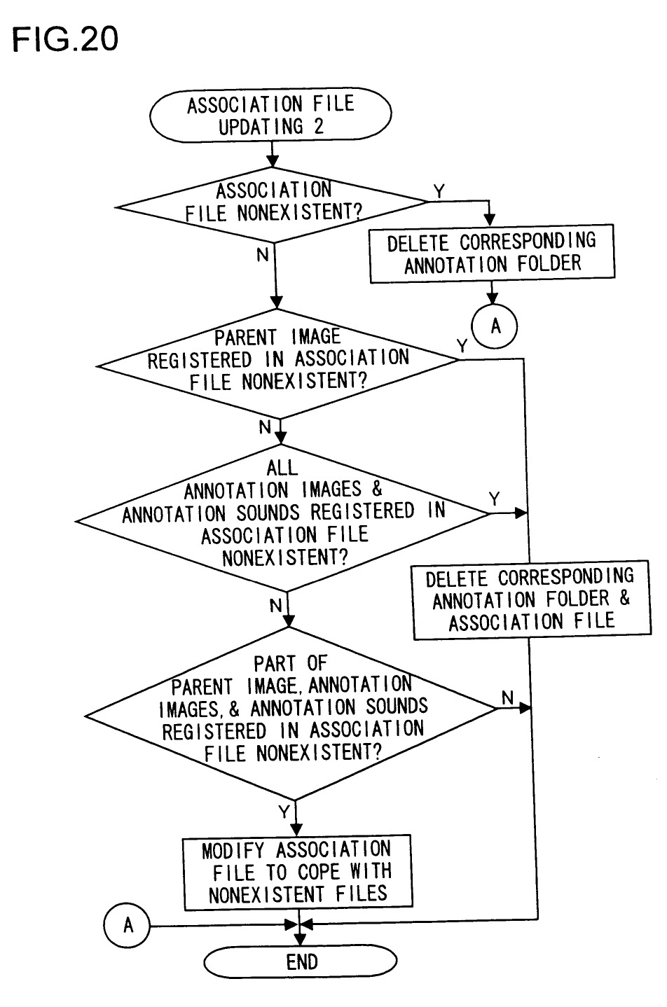

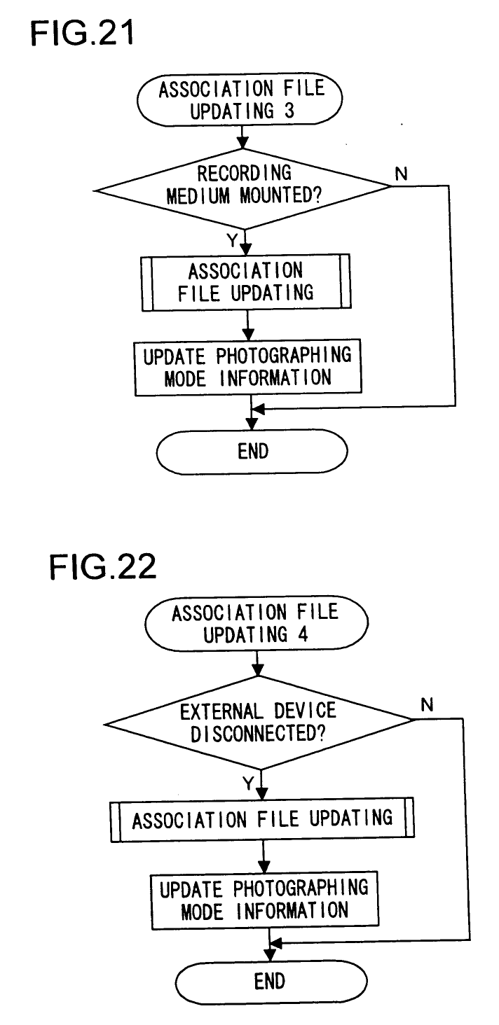

FIG. 19 shows the flow of operations described under (1) above, FIG. 20 shows the flow of operations described under (2) above, FIG. 21 shows the flow of operations described under (3) above, and FIG. 22 shows the flow of operations described under (4) above.

The digital camera 100 has a capability of providing a quick view, whereby an image or sound recorded on the recording medium 6 is reproduced in the photographing mode. The quick view capability can be used in any of the normal photographing, document photographing, image annotation photographing, and sound annotation recording modes. A quick view is started by operation of the quick view button 16.

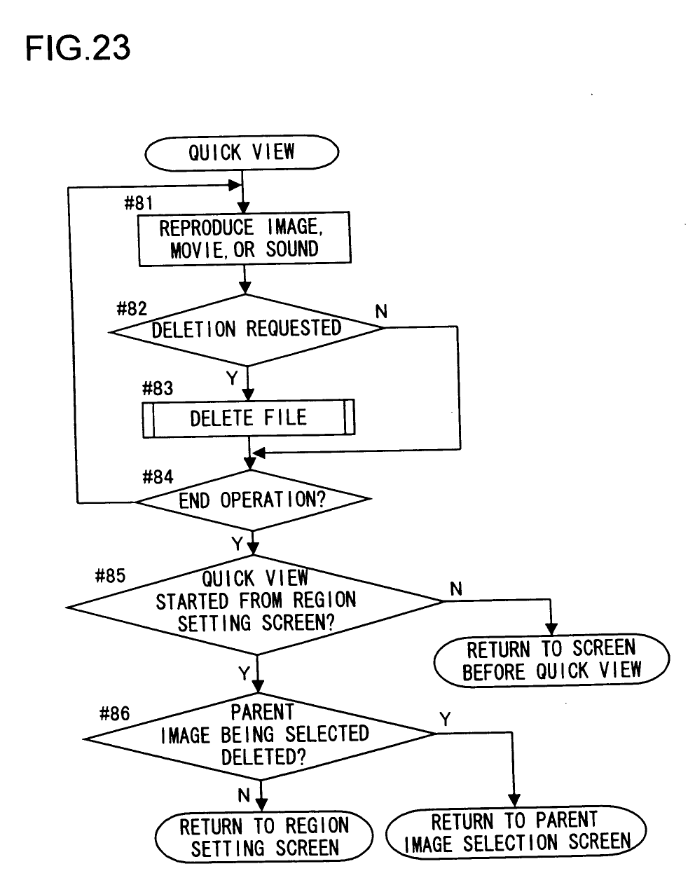

FIG. 23 shows the flow of operations performed to provide a quick view. When the quick view button 16 is operated, the image, movie, or sound that was captured or recorded most recently is reproduced (step #81). During reproduction, by operating, among the four direction keys 13, the left or right key, it is possible to switch the reproduced image or sound. During reproduction, by operating the delete button 17 (#82), it is possible to delete the file of the image or sound that is being reproduced (#83).

When the quick view button 16 is operated again, the quick view is ended (#84). When a quick view is ended, the screen that was displayed before the quick view was started is displayed again except if it was started when the region setting screen (FIG. 9, step #25) was being displayed. If the quick view was started when the region setting screen was being displayed, first, whether the parent image in which a region was then going to be set was thereafter deleted during the reproduction of the quick view or not is checked (#86). Then, if that image has not been deleted, the original region setting screen is displayed again; if that image has been deleted, there is no longer any sense in selecting that parent image, and therefore the parent image selection screen (FIG. 9, step #24) is displayed instead.

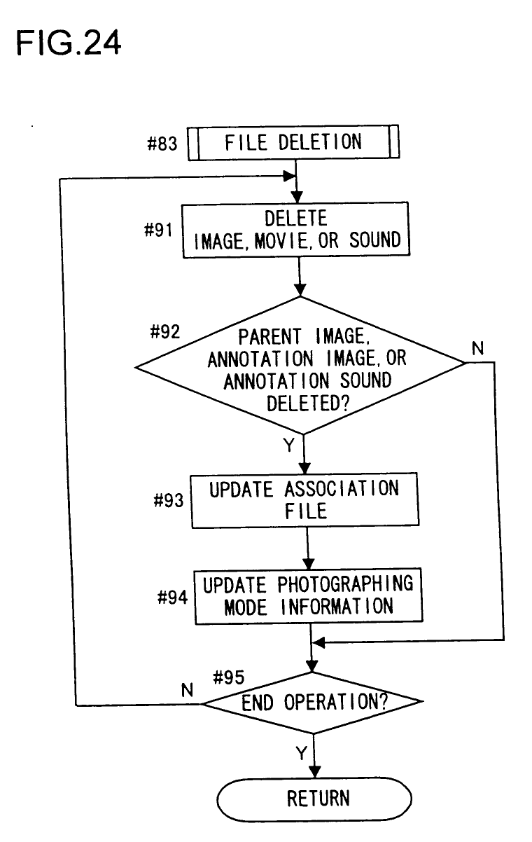

FIG. 24 shows the flow of operations performed to delete a file in step #83. When the delete button 17 is operated, the file of the image, movie, or sound that is being reproduced is deleted (step #91). Then, whether or not the deleted file is that of a parent image, annotation image, or annotation sound is checked (#92). If this applies, the association file and the photographing mode information are updated according to Tables 1 and 2 (#93 and #94).

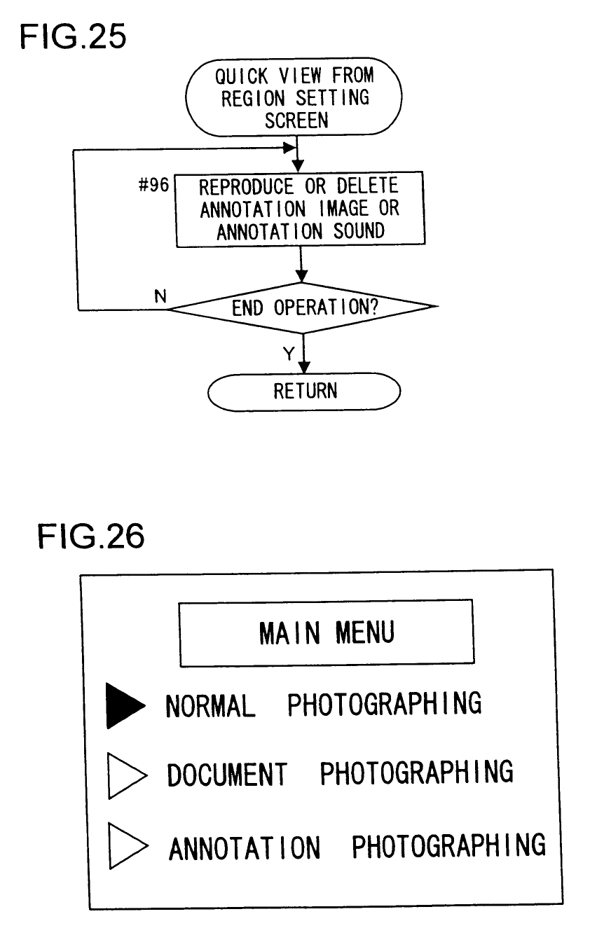

FIG. 25 shows another flow of operations performed to start a quick view when the region setting screen is being displayed. Through this flow, only the annotation images and annotation sounds added to the selected parent image are reproduced (step #96). Likewise, only the annotation images and annotation sounds added to the selected parent image can be deleted. This makes it easy to grasp what annotations are added to the parent image, and helps reduce the risk of erroneously deleting files that are unrelating to the parent image.

The annotation mode of the digital camera 100 thus far described consists of separate flows of operations for the image annotation photographing and sound annotation recording modes, of which one is selected in the main menu (FIG. 7). This configuration is convenient in a case where a plurality of annotation images are successively added to a parent image or a plurality of annotation sounds are successively added to a parent image. However, this is inconvenient in a case where both an annotation image and an annotation sound are added to a parent image, because it is then necessary to return to the main menu to switch the photographing mode. This requires somewhat troublesome operation.

Moreover, the method described thus far permits annotations to be added only to images that have already been recorded on the recording medium 6. Thus, when the user wants to capture an image first and then add an annotation thereto, the user needs to go to the main menu first to establish the normal photographing mode, then capture and record an image, then go to the main menu again to establish the image annotation photographing or sound annotation recording mode, and then capture an annotation image or record an annotation sound. This, too, requires somewhat troublesome operation.

Now, a description will be given of a method of efficiently setting the photographing mode in a case where different types (image and sound) of annotations are successively added and in a case where an annotation is added to an image that is going to be captured. FIG. 26 shows the main menu displayed when this method is used. Instead of separate image annotation photographing and sound annotation recording modes, here a single annotation photographing mode is provided, and is displayed parallel with the normal photographing and document photographing modes.

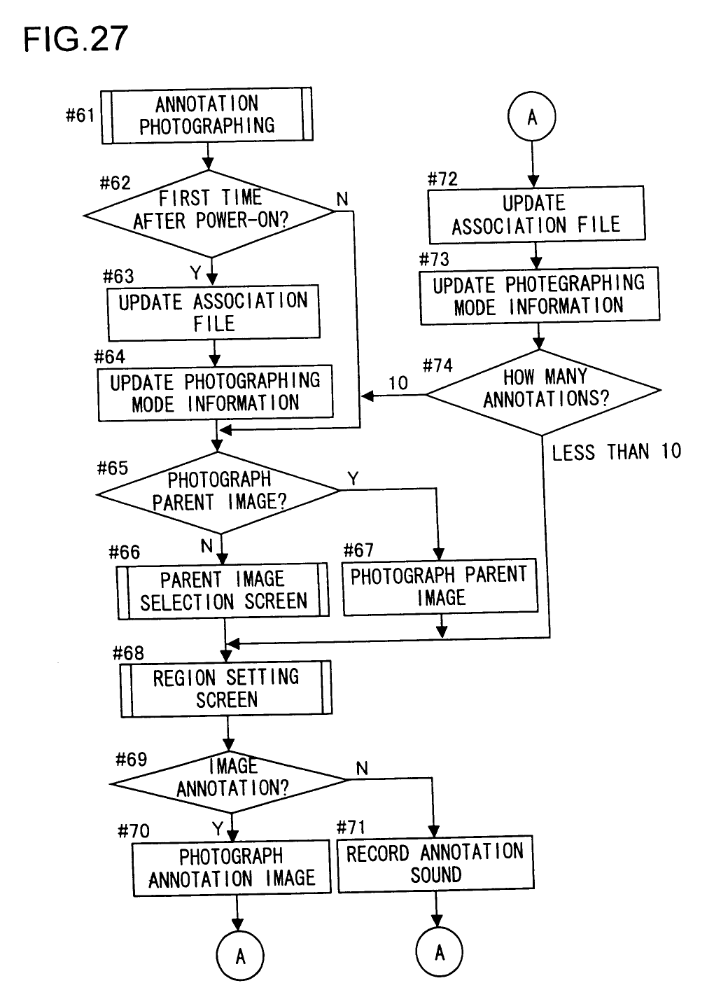

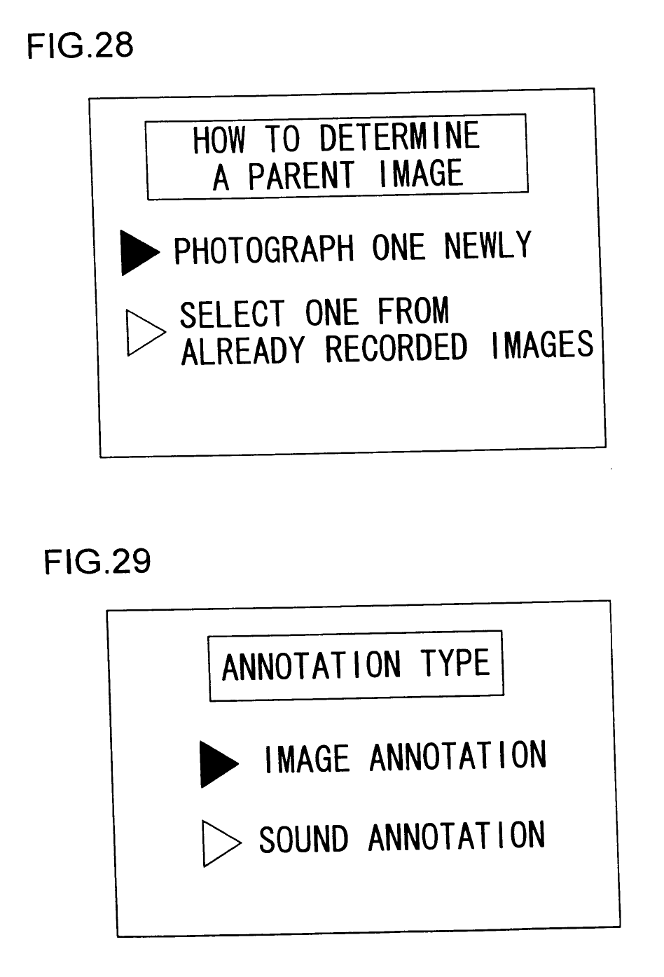

FIG. 27 shows the flow of operations performed in the annotation photographing mode. First, if this is the first time that this mode is established after the start of the supply of electric power, the association file and the photographing mode information are updated (steps #62 to #64). These steps are the same as steps #21 to #23 shown in FIG. 9 described earlier. Next, the screen shown in FIG. 28 is displayed to permit the user to choose whether to use as a parent image an image that is going to be captured or an image that has already been recorded on the recording medium 6 (step #65). The user selects the desired choice by operating the direction keys 13, and then determines the choice by operating the set button 18.

If an image that is going to be captured is chosen as a parent image, the flow proceeds to step #67; if an image that has already been recorded is chosen as a parent image, the flow proceeds to step #66. In step #66, the flow of operations shown in FIG. 11 described earlier is executed. In step #67, an image that is to be used as a parent image is captured just as in ordinary capturing of an image.

When the parent image is determined in this way, then, as in step #25 shown in FIG. 9, the region setting screen is displayed to permit setting of the position and size of the region to which to add an annotation (#68). After the region is set, the screen shown in FIG. 29 is displayed to permit the user to choose whether to use as an annotation an image or sound (#69). The user selects the desired choice by operating the direction keys 13, and determines the choice by operating the set button 18.

According to the choice made, an annotation image is captured (#70), or an annotation sound is recorded (#71). Then, as in steps #27 and #28 shown in FIG. 9, the association file and the photographing mode information are updated (steps #72 and #73). Then, whether the total number of annotations added to the parent image has reached the maximum number (here, ten) or not is checked (#74). If the maximum number has been reached, the flow returns to step #65 to permit the user to choose whether to use as a parent image an image that has already been recorded or an image that is going to be captured; if the maximum number has not been reached, the flow returns to step #68 to permit setting of the position and size of a region.

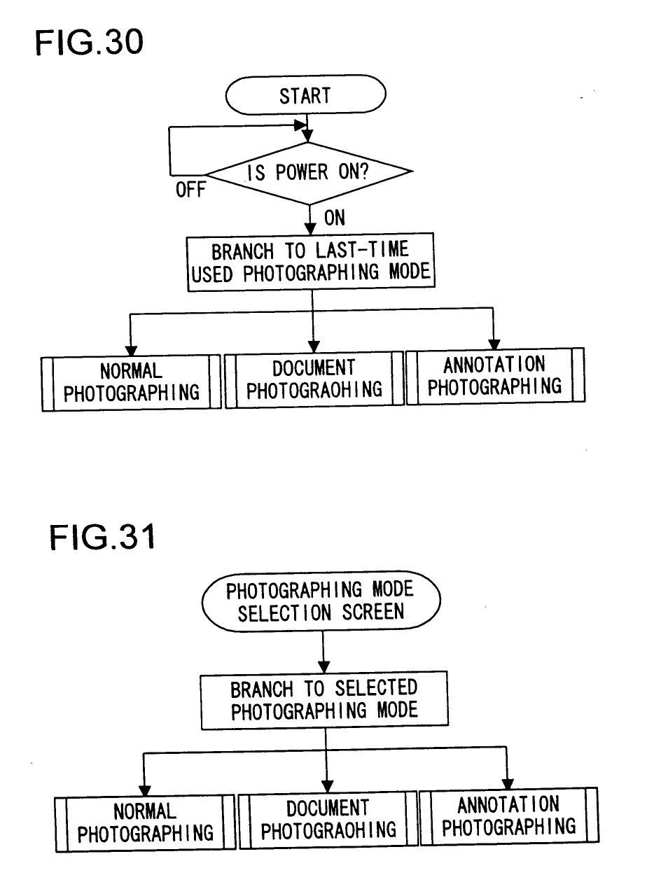

In this method of setting the photographing mode also, when the supply of electric power is stopped, the photographing mode at that moment is stored so that, when the supply of electric power is started next time, the stored photographing mode is restored. FIG. 30 shows the flow of operations performed to set the photographing mode when electric power starts to be supplied. FIG. 31 shows the flow of operations performed to change the photographing mode in the main menu.

This method permits efficient setting of the photographing mode in the following two aspects. When the user wants to add an annotation to an image that is going to be captured, the user can capture the image first and then immediately add an annotation thereto. In a case where an annotation image and an annotation sound are successively added to a single parent image, there is no need to select the parent image in the middle of the necessary operation.

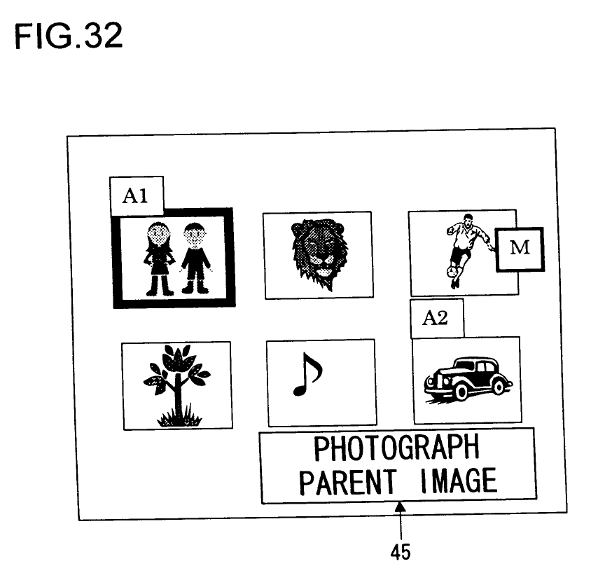

Here, the screen that permits choice of whether to use as a parent image an image that is going to be captured or an image that has already been recorded on the recording medium 6 and the screen that permits selection of which of the images already recorded on the recording medium 6 to use are displayed successively in different steps (FIG. 27, steps #65 and #66). These two screens may be merged into one. FIG. 32 shows an example of the screen displayed in that case.

This screen, like the one shown in FIG. 10 described earlier, displays in an arranged manner the thumbnail images of files recorded on the recording medium 6, and in addition displays an image 45, marked “capture a parent image,” that permits an image that is going to be captured to be used as a parent image. The user, by selecting this image 45, can request that an image that is going to be captured be used as a parent image, and, by selecting one of the thumbnail images other than the image 45, can request that an already recorded image be used as a parent image and simultaneously specify which of the already recorded images to use as a parent image. This helps reduce the number of times that the screen needs to be switched, and thus helps further increase efficiency.

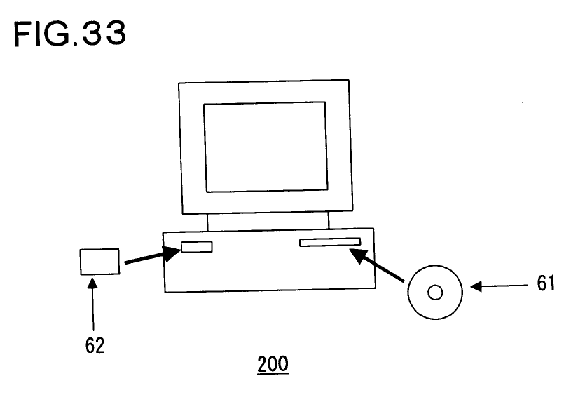

Now, a second embodiment of the invention will be described. FIG. 33 shows the personal computer 200 of this embodiment. The personal computer 200 is provided with a main unit incorporating a CPU, a hard disk, and other components and a display unit placed on the main unit. The personal computer 200 is further provided with a keyboard and a mouse, though these are not illustrated. An optical disk 61 and a memory card 62 incorporating semiconductor memory can be mounted in the main unit. The personal computer 200 cannot capture an image by itself, but, just like the digital camera 100 of the first embodiment, has a capability of adding an annotation to a region within an image.

A program to which operations relating to addition of an annotation to an image are written is stored on the optical disk 61, and the personal computer 200 uses the program after copying it to the hard disk it incorporates. An image to which to add an annotation is captured with an external device, for example the digital camera 100 of the first embodiment, and is then transported to the personal computer 200. For example, the image is transported by being recorded on the memory card 62, or by being transmitted via an unillustrated cable. The personal computer 200 stores the image transported thereto also on the hard disk. How image files are managed on the hard disk is the same as how they are managed in the digital camera 100 shown in FIG. 4. The program and images may be obtained by being downloaded from a Web site on the Internet or in the form of files attached to electronic mail.

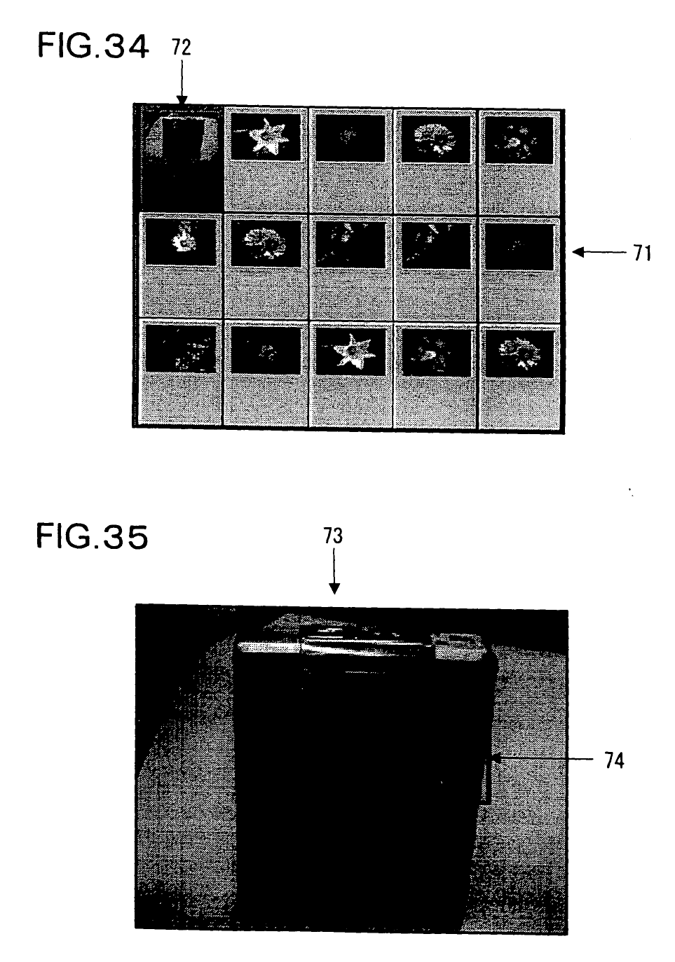

FIG. 34 shows an example of a parent image selection screen that permits selection of an image (parent image) to which to add an annotation. In the screen, there are displayed thumbnail images 71 of images stored on the hard disk. Thus user selects a parent image by operating the mouse or the direction keys on the keyboard. When a parent image is selected, a region setting screen that permits setting of a region within the parent image is displayed. For example, when the image corresponding to the thumbnail image 72 is selected, the region setting screen appears as shown in FIG. 35.

The region setting screen displays the selected parent image 73 along with a region frame 74 that indicates a region within it. This region frame 74 indicates the region that was used to adjust the focus of the taking lens when the parent image 73 was captured. As described earlier, the region used for focus adjustment is registered in the tag of the image file, and therefore the personal computer 200, by reading the information on that region from the tag, sets the region frame 74. When no information on the region used for focus adjustment is registered in the file, the region frame 74 is set at the center of the parent image.

If the region thus set by default agrees with the region to which the user wants to add an annotation, the user does not need to specify a region expressly. If the region set by default does not agree with the region to which the user wants to add an annotation, the user can specify a desired region by moving, enlarging, or reducing the displayed region frame by operating the mouse or the direction keys on the keyboard.

The personal computer 200, which does not have the capability of capturing images, uses as an annotation image an image stored on the hard disk, and uses as an annotation sound a sound stored on the hard disk. Except in these respects, the operations performed to add an annotation to a default or specified region are the same as those performed in the first embodiment. The personal computer 200 may be provided with a microphone and a loudspeaker so as to be capable of recording and reproducing an annotation sound.

Obviously, many modifications and variations of the present invention are possible in light of the above teachings. It is therefore to be understood that within the scope of the appended claims, the invention may be practiced other than as specifically described.

What is claimed is:

1. An image-processing apparatus comprising:
a display that displays an image;
a selector that selects an image displayed on the display;
a recorder that adds relevant information to a region within an image selected by the selector and that then records the relevant information on a recording medium;
a setter that, when an image to which to add relevant information is selected by the selector, initially sets a predetermined region within the image as a region to which to add the relevant information; and
a changer that changes the region to which to add the relevant information from the predetermined region initially set by the setter to a region specified by a user.

2. An image-processing apparatus as claimed in claim 1,
wherein the relevant information is annotation information.

3. An image-processing apparatus as claimed in claim 2,
wherein the display displays the predetermined region initially set by the setter and, when the changer changes the region to which to add the relevant information to the region specified by the user, changes the displayed region to the region specified by the user.

4. An image-processing apparatus as claimed in claim 2,
wherein, if relevant information has already been added to the image selected by the selector, the display displays a region to which the already added relevant information is added and the predetermined region initially set by the setter.

5. An image-processing apparatus as claimed in claim 4,
wherein the display displays in different manners the region to which the already added relevant information is added and the predetermined region initially set by the setter.

6. An image-processing apparatus as claimed in claim 2,
wherein the predetermined region initially set by the setter is a region at a center of the image.

7. An image-processing apparatus as claimed in claim 2,
wherein the predetermined region initially set by the setter is a region used for focus adjustment when the image selected by the selector was captured.

8. An image-taking apparatus comprising:
an image sensor that captures an image;
a display that displays the image captured by the image sensor;
a selector that selects an image displayed on the display;
a recorder that adds relevant information to a region within an image selected by the selector and that then records the relevant information on a recording medium;
a setter that, when an image to which to add relevant information is selected by the selector, initially sets a predetermined region within the image as a region to which to add the relevant information; and
a changer that changes the region to which to add the relevant information from the predetermined region initially set by the setter to a region specified by a user.

9. An image-taking apparatus as claimed in claim 8,
wherein the relevant information is annotation information.

10. An image-taking apparatus as claimed in claim 9,
wherein the display displays the predetermined region initially set by the setter and, when the changer changes the region to which to add the relevant information to the region specified by the user, changes the displayed region to the region specified by the user.

11. An image-taking apparatus as claimed in claim 9,
wherein, if relevant information has already been added to the image selected by the selector, the display displays a region to which the already added relevant information is added and the predetermined region initially set by the setter.

12. An image-taking apparatus as claimed in claim 11,
wherein the display displays in different manners the region to which the already added relevant information is added and the predetermined region initially set by the setter.

13. An image-taking apparatus as claimed in claim 9,
wherein the predetermined region initially set by the setter is a region at a center of the image.

14. An image-taking apparatus as claimed in claim 9,
wherein the predetermined region initially set by the setter is a region used for focus adjustment when the image selected by the selector was captured.

15. A program product in which is stored a program for making a computer perform the steps of:
displaying an image on a display and selecting the image to which to add relevant information;
initially setting a predetermined region within the selected image as a region to which to add the relevant information;
changing the region to which to add the relevant information from the initially set predetermined region to a region specified by a user; and
adding the relevant information to the changed region and recording the relevant information.

16. A program product as claimed in claim 15,
wherein the relevant information is annotation information.

17. A program product as claimed in claim 16, further making the computer perform the step of:
displaying the initially set predetermined region and, when the region to which to add the relevant information is changed to the region specified by the user, changing the displayed region to the region specified by the user.

18. A program product as claimed in claim 16, further making the computer perform the step of:
if relevant information has already been added to the selected image, displaying a region to which the already added relevant information is added and the initially set predetermined region.

19. A program product as claimed in claim 18,
wherein the region to which the already added relevant information is added and the initially set predetermined region are displayed in different manners.

20. A program product as claimed in claim 16,
wherein the initially set predetermined region is a region at a center of the image.

21. A program product as claimed in claim 16,
wherein the initially set predetermined region is a region used for focus adjustment when the selected image was captured.
